(19) United States
(12) Patent Application Publication
(10) Pub. No.: US 2005/0097196 A1
(43) Pub. Date: May 5, 2005

(54) Network status messaging

(76) Inventors: Leszek Dariusz Wronski, Dayton, OH (US); Barrie Richard Timpe, Miamisburg, OH (US)

Correspondence Address: STEVENS & SHOWALTER LLP, 7019 CORPORATE WAY, DAYTON, OH, 45459-4238, US

(21) Appl. No.: 10/679,109

(22) Filed: Oct. 3, 2003

(51) Int. Cl. G06F 15/173

(52) U.S. Cl. 709/223

(57) ABSTRACT

In a register insertion network having a plurality of nodes, each node generates status messages including at least an identification of the node that generated the status message and a message age. These status messages are periodically transmitted by each node of the network and received at each node of the network. When received, the status messages are aged and retransmitted onto the network unless the receiving node was the source of the status message in which case it is removed from the network. Node statuses, determined from the status messages, are stored at each node and enable the determination of network size, structure or topology and status of the nodes to assist in monitoring and testing of the network.

### BACKGROUND OF THE INVENTION

The present invention relates in general to register insertion networks having a plurality of nodes and, more particularly, to a method for operating such networks wherein each node generates status messages that are periodically transmitted so that all other nodes in a network can determine the status of the network. Typically, a network comprises a closed ring, i.e., nodes in a closed ring are connected so that each node in the ring can receive its own messages. The status of the network, including the topology of the closed ring, can then be determined by any ring node from the status messages. The status of the network, including the topology of the closed ring, can also be determined by at least one node that is not connected into the ring but is connected to the ring to receive the status messages. Such a node will be referred to herein as a monitor node.

Register insertion networks typically utilize unique network identifications (IDs) for each node of the network. Removal of packets from the network may be performed using destination removal or source removal. Broadcast networks typically utilize source removal where the packet is removed when the incoming packet's ID matches the local node's ID. It is also common to utilize an “age” field that is modified (for example incremented or decremented) as the packet is retransmitted. When the age of a packet reaches a maximum value (or minimum value if the age field is decremented on each retransmission), the packet is removed from the network to eliminate unwanted packets referred to as “expired” packets. When source removal is used, the age field of a node's own packets received back for removal can be used to calculate the network size, i.e., if the initial age is set to 0 and the age of a node's own packets come back as X, then there are X+1 nodes in the network. Network latency can also be determined by setting a timer when a packet is sent out and then stopping the timer when the packet is received back by the source and removed from the network so that the resulting timer reading is the network latency.

While network size and latency are important for control and management of a network, they do not provide knowledge of the actual structure of the network or the status of other nodes within the network. Further, if network changes are made between times that packets are sent by a node, the information determined from previous transmissions may be inaccurate, particularly for nodes that are not very active.

Accordingly, there is a need for a method for operating a network that enables monitoring of many aspects of the network including not only size and latency but also network structure and status of nodes within the network. In one form, the network could be monitored by a node that is not within a network ring but is connected to the network ring so that monitoring can be performed in a manner that is not ring invasive.

### SUMMARY OF THE INVENTION

This need is met by the invention of the present application wherein each node of a network having a plurality of nodes generates status messages including at least an identification of the node that generated the status message and a message age. These status messages are periodically transmitted by each node of the network and received at each node of the network. When received, the status messages are aged and retransmitted unless the receiving node was the source of the status message in which case it is removed from the network. Node statuses, determined from the status messages, can be used at each node to enable the determination of network size, structure or topology of the network and status of the nodes in the network to assist in monitoring and testing the network.

Other features and advantages of the invention will be apparent from the following description, the accompanying drawings and the appended claims.

### BRIEF DESCRIPTION OF THE DRAWINGS

FIG. 1 is a block diagram of a four node register insertion network operable in accordance with the present invention;

FIG. 2 is a network status lookup table that can be used in the present invention;

FIG. 3 is a block diagram of a four node register insertion network including a node ID error that is easily detected using the invention of the present application; and

FIG. 4 is a simplified diagram of framing logic within the network logic which controls transmission of status messages of the present invention.

### DETAILED DESCRIPTION OF THE INVENTION

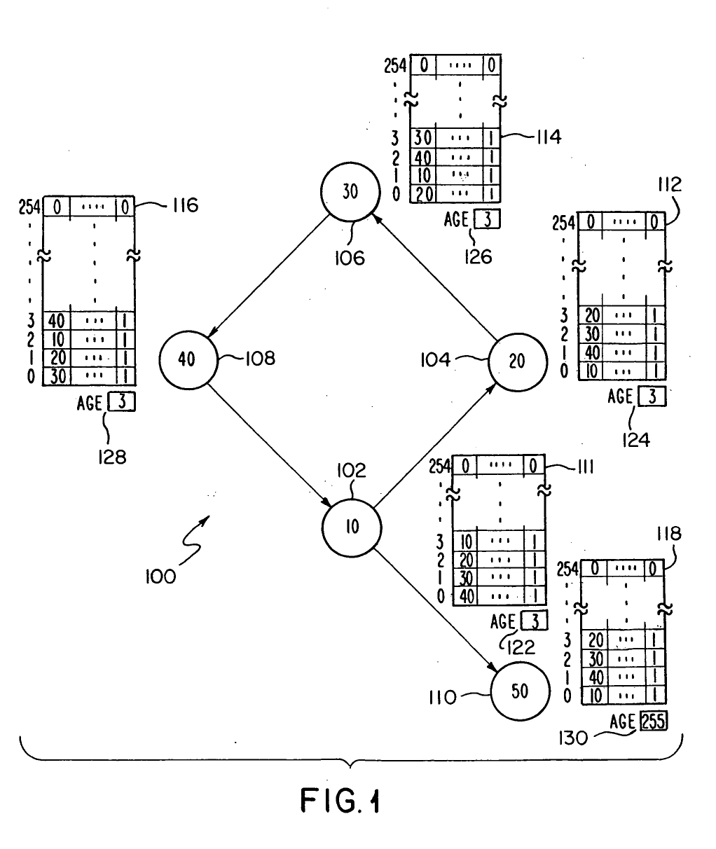

Reference will now be made to the drawings wherein FIG. 1 is a block diagram of an illustrative register insertion network 100 operable in accordance with the present invention. While networks having any reasonable number of nodes can be operated using the present invention (a working embodiment accommodates nodes 0-254), for ease of description, the illustrated network 100 has only four nodes 102, 104, 106, 108 connected into a closed ring. Each of the nodes 102-108 has a node identification (ID) 10, 20, 30, 40, respectively. At least one monitor node (a node that receives data from the ring but is not connected into the ring), illustrated by a monitor node 110 having a node ID of 50, can be connected into the network 100 for noninvasive network monitoring purposes as will be described hereinafter. The connection of the monitor node 110 can be performed in a variety of ways including, for example, connection with a network switch, redundant physical interface, optical splitter, and the like as will be apparent to those skilled in the art.

Network data packets are illustrated as being transmitted around the closed ring of the network 100 in a counterclockwise direction as indicated by the arrows extending between the nodes 102-108. Data packets are formatted and transmitted in a conventional manner within the network 100 and source removal is used so that packets are removed by the nodes when an incoming packet's ID matches the local node's ID. An “age” field is included in each data packet with the age field being modified (incremented in the illustrated embodiment, although age decrementing can also be used in the present invention) as the packet is retransmitted by each node. When the age of a packet reaches a maximum value, such as 255, (or minimum value if the age field is decremented on each retransmission), the packet is removed to eliminate unwanted packets, referred to as “expired” packets, from the network 100.

A register insertion network having a plurality of nodes, such as the network 100, can be operated in accordance with the present invention by generating status messages at each node of the network 100 with the status messages each including at least an identification of its generating node (node ID) and a message age. Preferably, the status messages also include data representative of operating characteristics of the nodes that generate them. Accordingly, in addition to node ID and message age, the status messages can also include data representing the node ID of the node immediately preceding or upstream of the node that generated the message. An indication of whether or not a redundant link is available to the node can be included. The status of data transmission can be included, for example by indicating whether the laser(s) on transmission link(s) from the node are enabled or shut down and whether or not transmission from the node by a node host computer onto the network is enabled or disabled. The status of data reception can be included, for example by identification of the link being used by the node for reception, whether the node is enabled to receive data from the network, whether retransmission of incoming network data received by the node is enabled, whether the link currently being used by the node for reception is up and whether signals are being detected on reception links. Of course, any type of node control and/or status information that would be beneficial for operation of the network can be included in the status messages.

Each of the nodes 102-110 periodically transmits its status messages, for example, a status message can be transmitted from each node of the network 100 with a periodicity of about one millisecond (status messages for the monitor node 110 do not reach the closed ring of the network 100 since it is not connected into the ring). While any reasonable period can be selected for status message transmissions, the period should ensure that the status messages are received back by their originating nodes before another status message is sent.

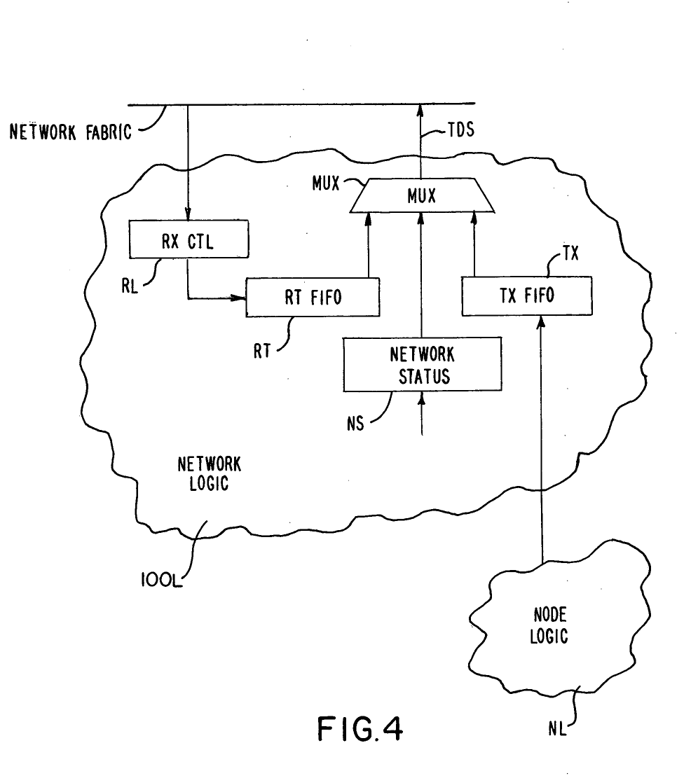

Status messages in accordance with the present invention can be generated in a number of ways, however, the most efficient and effective way is for network logic 100L at each node to automatically transmit status messages at a fixed interval, see FIG. 4. The network logic 100L can be configured in field programable gate arrays (FPGAs), application specific integrated circuits (ASICs) or using other appropriate technology as will be apparent to those skilled in the art. As shown in FIG. 4, there are three sources of transmission data. In descending order of transmission priority, the transmission data are 1) retransmit data, 2) network status messages and 3) transmit data (although the transmit data may be given priority over the network status messages in some applications). The retransmit data is sent from a first-in-first-out FIFO register RT to which received data is written by receiving logic RL of the network logic 100L. A transmit FIFO register TX receives data to be transmitted onto the network 100 from the local node logic NL. The transmit data from the local node includes network interrupts and, if shared memory is used, shared memory writes. The network status register NS contains the status of the respective node including the status for the applicable entries in the status message.

These three data sources are selectively multiplexed onto the transmit data stream TDS by a multiplexer MUX. Since retransmission traffic has the highest priority, any time data is available in the RT FIFO, it will be sent out as soon as possible. A network status message timer, part of the network logic 100L, determines when to send status messages, for example, approximately every millisecond as previously noted. If there is no retransmission traffic and it is time to send a status message, the network logic takes the network status, frames it, and it is driven out on the transmit link. If there is no retransmission traffic and no network status message is to be sent, the network logic selects the TX FIFO as the data source. If there is no data in the TX FIFO, the network logic 100L sends idle patterns to the network fabric.

Accordingly, for the illustrated arrangement, transmission of the status messages is a decision made locally within the network logic 100L with the only delay possible being a waiting time for completion of an in-progress message or retransmission of data received from the network. Having the network logic generate and transmit the status messages results in a symmetric arrangement where no special node or configuration is required. In addition, the decision to transmit a status message is only based on local status, elapsed time and any necessary wait for a message in progress or retransmission traffic to be finished so that no centralized coordination of these tasks is necessary across the network.

The status messages are received at each node 102-110 of the network 100, the messages are then aged and retransmitted onto the network 100 in the same manner as other data packets traveling around the network 100 (the node 110 ages and retransmits the messages, however, since the node 110 is not connected into the ring of the network 100 or to another node, i.e., nothing is connected to the output of the node 110, the retransmitted data is effectively discarded). Received status messages can be stored at each node; however, it is currently preferred to process the status messages with resulting node statuses being stored. As will be apparent, it is also possible to utilize the status messages of the present invention in status routines that would not directly or indirectly store the status messages. The node statuses are stored at addresses corresponding to the ages of the status messages and hence the node statuses. In other words, if a status message has an age of 0, it's node status is stored in an address corresponding to an age of 0 (for sake of simplicity, herein address 0), if a status message has an age of 1, it's node status is stored in an address corresponding to an age of 1 (for sake of simplicity, herein address 1), etc.

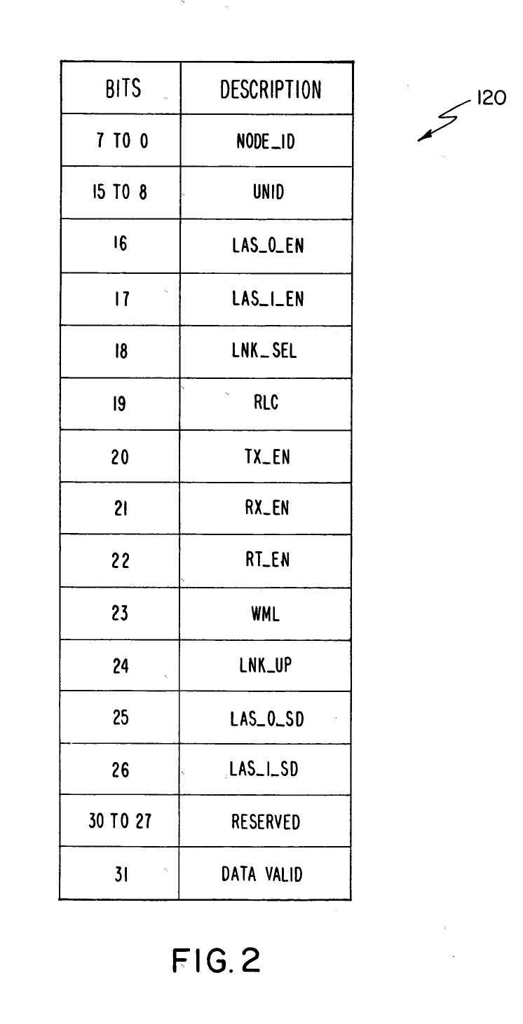

Node statuses are stored in a lookup table (LUT) 111, 112, 114, 116, 118 in each of the nodes 102-110, respectively. Illustrative data for the node statuses is shown in FIG. 2 which schematically illustrates a network status lookup table entry 120. In the illustrated embodiment, each node status entered in a lookup table is allocated 32 bits with bits 7 to 0, NODE_ID, defining the node ID; bits 15 to 8, UNID, defining the immediately upstream node ID; bit 16, LAS_{—}0_EN, indicating whether the laser output on Link 0 is shut down “0” or is enabled “1”; bit 17, LAS_{—}1_EN, indicating whether the laser output on Link 1 is shut down “0” or is enabled “1”; bit 18, LNK_SEL, indicating which link is being used for network reception, “0” indicates Link 0 is being used while “1” indicates that Link 1 is being used; bit 19, RLC (Redundant Link Capable), indicating whether a redundant link is available, “1” indicates availability and “0” indicates unavailability; bit 20, TX_EN, indicates that network transmission from the host is disabled “0,” or normal transmission is enabled “1” [if shared memory is provided on the network, writes to shared memory update the node's local memory but are not transmitted onto the network]; bit 21, RX_EN, indicates whether network receive operation is enabled for the node “1” or disabled “0”; bit 22, RT_EN, indicates whether retransmission of incoming network data and interrupts is disabled “0” or enabled “1”; [if shared memory is provided, a “1” in bit 23, WML (Write Me Last), specifies that writes to shared memory occur only after corresponding messages traverse the ring and are removed by the originating node—a “0” specifies normal operation, where writes to shared memory do not rely on the reception of network traffic]; bit 24, LNK_UP, indicates whether the link is currently up “1” or currently down “0”; bit 25, LAS_{—}0_SD, indicates that an optical signal is detected on Link 0, a “0” indicates no signal is detected on Link 0 while a “1” indicates a signal is detected on Link 0; bit 26, LAS_{—}1_SD, indicates that an optical signal is detected on Link 1, a “0” indicates no signal is detected on Link 1 while a “1” indicates a signal is detected on Link 1; bits 30-27 are currently reserved; and, bit 31 is a data valid bit which is updated as being valid “1” upon each write of a lookup table entry 120.

Operation of the network 100 utilizing the present invention will now be described with reference again to FIG. 1. Since operation of all of the nodes 102-110 are substantially the same, operation of the nodes 102-110 is described in response to the node 102 generating and transmitting a status message. In the illustrated embodiment, originating messages are given a message age of 0 with nodes receiving the messages, aging the messages by incrementing them by one and retransmitting the messages. Accordingly, when the node 102 sends a status message, SM102, it has an age of 0.

When the node 104 receives the status message SM102 from the node 102, it processes it to form a node status and stores the node status in address 0 of the LUT 112 since the age of SM102 is 0. As shown in FIG. 1, the node status stored in address of LUT 112 includes a node ID of 10 and data valid bit of 1. The node 104 ages SM102 by incrementing its age by one and retransmits the aged status message onto the network 100 where it is received by the node 106. It is noted that additional information, such as the information represented in FIG. 2, is actually stored in the respective lookup table entries for all the nodes but only the node ID and data valid bit are shown in the drawings for sake of simplicity.

When the node 110 receives the status message SM102 from the node 102, the node 110 processes the status message SM102 to form a node status and stores the node status in address 0 of LUT 118, since SM102 has an age of 0 when received by the node 110. As shown in FIG. 1, the node status stored in address 0 of LUT 118 includes a node ID of 10 and a data valid bit of 1. The node 110 ages SM102 by incrementing its age by one but is unable to retransmit it onto the network 100 since the node 110 is a monitor node. More specifically, while the node 110 retransmits this data, since the node 110 is not connected into the closed ring of the network 100, i.e., nothing is connected to the output of the node 110, the retransmitted data is effectively discarded.

When the node 106 receives the status message SM102, the node 106 processes it to form a node status and stores the node status in address 1 of LUT 114, since SM102 has an age of 1 when received by the node 106. As shown in FIG. 1, the node status stored in address 1 of LUT 114 includes a node ID of 10 and a data valid bit of 1. The node 106 ages SM102 by incrementing its age by one and retransmits the aged status message onto the network 100 where it is received by the node 108.

When the node 108 receives the status message SM102, the node 108 processes the status message to form a node status and stores the node status in address 2 of LUT 116, since SM102 has an age of 2 when received by the node 108. As shown in FIG. 1, the node status stored in address 2 of LUT 116 includes a node ID of 10 and a data valid bit of 1. The node 108 ages SM102 by incrementing its age by one and retransmits the aged status message onto the network 100 where it is received by the node 102.

When the node 102 receives the status message SM102, the node 102 processes the status message to form a node status and stores the node status in address 3 of LUT 111, since SM102 has an age of 3 when received by the node 102. As shown in FIG. 1, the node status stored in address 3 of LUT 114 includes a node ID of 10 and a data valid bit of 1. The node 102 recognizes that the node ID of SM102 is its own node ID and removes SM102 without aging or retransmitting it. The age of status messages that are removed by the node 102, i.e. 3, is set as the age of the node 102 or node age 122. The size of the closed ring of the network 100 can be determined from the node age. When message age is initially set to 0 and is incremented by each node through which it passes, as in the illustrated embodiment of the present invention, size of the closed ring of the network 100 is equal to node age+1. It should be apparent that the node ages 122, 124, 126, 128 for each of the network nodes 102-108, respectively, are the same, i.e., 3. In addition to determining the size of the closed ring of the network 100 (network size=node age+1), node age corresponds to the highest valid stored node status in the node lookup table. Thus, with a node age of 3 (the highest address of a stored valid node status), there are valid node statuses stored at addresses 0, 1, 2 and 3, i.e., one for each of the four nodes in the closed ring of the network 100.

If a node's own status message is not received back by the node within a defined time period, for example two times the periodic rate of transmission of status messages, an error is indicated and the node age is set to an illegal age, for example in a network that can have up to 255 nodes, 0-254, the age could be set to 255 (FF-hexadecimal). The node 110 never receives its status messages back from the network 100 because the node 110 is not connected into the closed ring of the network 100 so that it cannot receive its own messages. Accordingly, the node 110 sets its node age 130 to 255.

By following network operation in response to status messages generated by the nodes 104, 106 and 108 in the same manner as described above with regard to the node 102, the lookup table entries shown in FIG. 1 result for the lookup tables 111, 112, 114, 116, 118. By reviewing the lookup table entries, for example by reading the stored node statuses, in any of the network ring nodes 102-108 or the network monitor node 110, the structure of the network 100 can be determined by identifying an immediately adjacent, first upstream node by the node identification of the node status corresponding to an initial message age. Any additional upstream nodes can also be identified by the node identifications of the node statuses corresponding to the initial message age that has been aged by the additional upstream nodes. More particularly, if the network comprises N nodes, the structure of the network can be determined from the stored node statuses by determining a node that is a distance one upstream from a given node by using the node identification of the node status corresponding to an initial message age. Since N can be equal to 1, if a node is connected to transmit directly back to itself, the immediately upstream node can be the node itself. If N≧2, additional nodes that are distances up through N from the given node can be determined by using the node identifications of the node statuses corresponding to the initial message age that has been aged by one through N−1.

With reference to the illustrated embodiment, the node ID stored in address 0 receives data from the node ID stored in address 1 which receives data from the node ID stored in address 2 which receives data from the node ID stored in address 3, etc. Thus, from the entries in any of the lookup tables 111, 112, 114, 116 the structure or topology of the closed ring of the network 100 can be determined to be node ID 10 transmits to (→) node ID 20 which transmits to (→) node ID 30 which transmits to (→) node ID 40 which transmits to (→) node ID 10 so that the closed ring of the register insertion network 100 is configured as shown in FIG. 1.

The network structure indicated in the lookup table 118 of the monitor node 110 indicates a partial ring with node ID 20→node ID 30→node ID 40→node ID 10 but there is no indication of closure of the ring; however, the ring can be considered to be closed by presuming that the node ID stored in address 0 transmits to the node ID stored in the highest valid address, in the present example, node ID 10 transmits to node ID 20. More specifically, the ring connection for node 110 is not closed (node age set to FF), but given the structure in the lookup table 118 of the node 110, it can be inferred that the node's 110 connection is a segment off of a closed ring of the network 100, which includes the nodes 102, 108, 106, and 104. It is again noted that a closed ring of a network consists of a complete path of the node's transmission, i.e., data transmitted from a node's transmitter is received back by its receiver. Typically this transmission is through other nodes, however, a one node closed ring can be defined by connecting a node's transmitter to its receiver.

In addition to network size and structure or topology, the status messages of the present invention enable the network to be monitored and tested. If one or more monitor nodes, like the node 110 of FIG. 1, are provided, the monitoring can be performed without intrusion into a closed ring of the network. An example of a monitoring function is a general sanity check that can be performed by determining whether valid data are stored in addresses of the lookup table corresponding to node ages of 0 through the locally determined node age. If there are entries in the lookup table beyond the address corresponding to the node age, then a node ID error may have occurred since no such entries should be present. However, since dynamic network topology changes are possible, if the size of a network ring has been reduced from a larger configuration, the number of entries in the lookup tables marked valid will exceed the current ring size, as indicated by the local node age, and no network error will have occurred.

Since it is not generally practical to invalidate the extraneous entries produced by reducing the size of the network automatically via hardware, when the processing node encounters a situation where the number of entries marked valid in the lookup table exceeds the current ring size, it is currently preferred to clear each of the respective entries in the lookup table. In a working embodiment, writing to lookup table entries by the node clears the contents of the table entry, including the data valid bit. After the offending entries, or the entire lookup table, has been cleared, the node waits for a time period greater than the status message update period, and rereads the lookup table. If the condition persists, a network error is indicated.

Network latency can also be automatically checked using the status messages. It is currently preferred to deploy a timer which is cleared and enabled on transmission of a local network status message. The timer value is latched on reception of a node's own network status message and presented to a register which allows the node or other network control system to determine network transmission latency around the ring for the current network loading. The timer automatically updates on reception of its own native status messages and requires no additional network traffic to determine network latency.

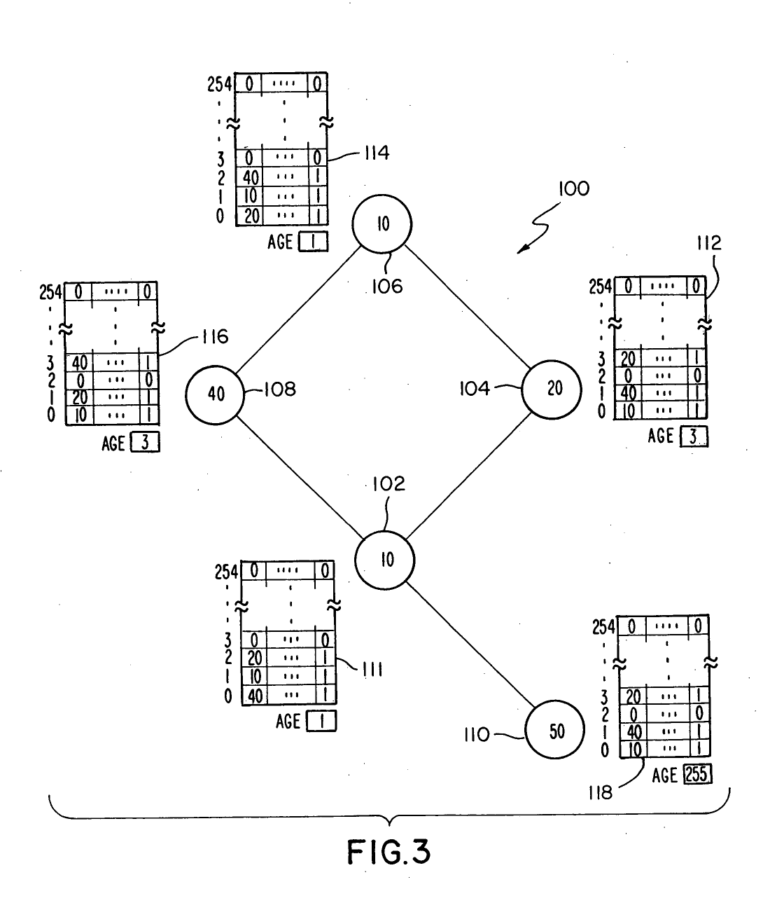

FIG. 3 illustrates detection of a node ID error. In FIG. 3, the nodes of the register insertion network 100 of FIG. 1 have been modified to include a node ID error (duplicate assignment of node IDs). The nodes are labeled the same as in FIG. 1, however, the node 106 is erroneously identified by the node ID 10, the same node ID as the node 102. This node ID error can be identified in each of the nodes 102-110 by a review of the node statuses stored in the lookup tables 111, 112, 114, 116, 118. In particular, in the nodes 102 and 106, it is apparent that another node has been assigned the same node ID since the node ID 10 is not the last valid entry in their lookup tables 111, 114. In the nodes 104, 108 and 110, a network error is apparent since there is an entry in the lookup table that is not valid, i.e., there is no valid entry at address 2. Thus, the first upstream occurrence of a node with a duplicate node ID can be determined on each of the nodes.

An example of network testing using the status messages of the present application is remote measurement of the clock frequency of each of the nodes on a network. All clocks within a network have to be within given specifications. In the past, each of the clocks of the individual nodes had to be measured to determine compliance with the clock specifications. But by repeatedly introducing a node ID error into any one of the network nodes, for example as described with regard to a node ID error relative to FIG. 3, all clock speeds around the network can be easily determined. With reference to FIG. 3, if the node 102 is set to have the same node ID as the node 106, 10 as shown, and then sends status messages as described above, the node 106 removes those messages but sends out its own status messages which are removed by the node 102. By setting a timer when a status message is sent out from the node 102 and stopping the timer when a status message having its own node ID, 10, is sent by the node 106, over time, the time periods will shift, i.e., either increase or decrease, with the shifts and directions of shifts correlating to the difference between the clock speed of the node 102 and the-clock speed of the node 106. If the clock speeds are identical, there will be no shift in the period. Thus, by setting the node ID of the node 102 to each of the node ID's within a closed ring of the network, the clock speed of each of the nodes in the ring can be determined from the ring latencies that are automatically measured using the status messages.

Of course, by monitoring the operating characteristics of the individual nodes that are stored in the lookup tables of the individual network nodes, a wide variety of network problems can be detected. Once detected, the status messages of the present application can be used to assist in diagnostics, including locations of cable breaks, duplicate node IDs, incorrectly configured nodes, and the like. Further, problem detection can be used to direct routine maintenance of a network so that detected problems can be corrected before they create network failures. In addition, network nodes can be interconnected using switched connections so that detected network problems, even those that create network failures, can be corrected by controlling the switch connections to bypass the detected problems. Numerous other uses of the status messages of the present application will be apparent to those skilled in the art from the disclosure of the present application.

Having thus described the invention of the present application in detail and by reference to preferred embodiments thereof, it will be apparent that modifications and variations are possible without departing from the scope of the invention defined in the appended claims.

1. A method for operating a network having a plurality of nodes comprising:
generating status messages at each node of said network, said status messages each including at least a node identification and a message age;
periodically transmitting said status messages from each node of said network;
receiving said status messages at each node of said network;
aging said status messages at each node of said network; and
retransmitting said aged status messages at each node of said network.

2. A method for operating a network as claimed in claim 1 wherein periodically transmitting said status messages from each node of said network is performed approximately once every millisecond.

3. A method for operating a network as claimed in claim 1 wherein periodically transmitting said status messages from each node of said network is automatically performed by network logic.

4. A method for operating a network as claimed in claim 1 further comprising:
connecting at least one node within said network as a monitor node;
receiving said status messages at said at least one monitor node; and
monitoring said network using said status messages received by said at least one monitor node.

5. A method for operating a network as claimed in claim 1 further comprising removing status messages from said network at nodes having the same node identifications as said status messages.

6. A method for operating a network as claimed in claim 5 further comprising using the age of status messages removed by each node as a node age.

7. A method for operating a network as claimed in claim 6 further comprising determining the size of said network based on said node age.

8. A method for operating a network as claimed in claim 7 wherein said message age is set to zero upon generation, aging said status messages comprises incrementing said message age by one and the size of said network is equal to the node age plus one.

9. A method for operating a network as claimed in claim 8 further comprising storing said node statuses at each node of said network at addresses corresponding to ages associated with said node statuses with said node age corresponding to the highest valid stored node status.

10. A method for operating a network as claimed in claim 1 further comprising storing node statuses from said status messages at each node of said network.

11. A method for operating a network as claimed in claim 10 wherein storing node statuses comprises storing a data valid indicator.

12. A method for operating a network as claimed in claim 10 further comprising determining the structure of said network from said stored node statuses.

13. A method for operating a network as claimed in claim 12 wherein said network comprises N nodes and determining the structure of said network from said stored node statuses comprises:
determining a node that is a distance one upstream from a given node by using the node identification of the node status corresponding to an initial message age; and
if N>2, determining additional nodes that are distances two through N from said given node by using the node identifications of the node statuses corresponding to said initial message age that has been aged by one through N−1.

14. A method for operating a network as claimed in claim 12 wherein determining the structure of said network from said stored node statuses comprises:
reading said stored node statuses;
identifying an immediately adjacent, first upstream node by the node identification of the node status corresponding to an initial message age; and
identifying any additional upstream nodes by the node identifications of the node statuses corresponding to said initial message age that has been aged by said additional upstream nodes.

15. A method for operating a network as claimed in claim 12 wherein determining the structure of said network from said stored node statuses comprises:
reading said stored node statuses;
identifying said network as comprising N nodes where N is the number of node statuses that have been stored and read;
identifying an immediately adjacent, first upstream node by the node identification of the node status corresponding to an initial message age; and
if N>2, identifying any additional upstream nodes by the node identifications of the node statuses corresponding to said initial message age that has been aged by said additional upstream nodes.

16. A method for operating a network as claimed in claim 10 wherein storing said node statuses at each node of said network comprises storing said node statuses at each node at addresses corresponding to ages associated with said node statuses.

17. A method for operating a network as claimed in claim 16 further comprising determining the structure of said network from said stored node statuses.

18. A method for operating a network as claimed in claim 17 wherein said network comprises N nodes and determining the structure of said network from said stored node statuses comprises:
determining a node that is a distance one upstream from a given node by reading the node identification of the node status stored at an address corresponding to an initial message age; and
if N>2, determining additional nodes that are distances two through N from said given node by reading the node identifications of the node statuses stored at addresses corresponding to said initial message age that has been aged by one through N−1.

19. A method for operating a network as claimed in claim 17 wherein determining the structure of said network from said stored node statuses comprises:
reading said stored node statuses;
identifying an immediately adjacent, first upstream node by the node identification of the node status stored at an address corresponding to an initial message age; and
identifying any additional upstream nodes by the node identifications of the node statuses stored at addresses corresponding to said initial message age that has been aged by said additional upstream nodes.

20. A method for operating a network as claimed in claim 17 wherein determining the structure of said network from said stored node statuses comprises:
reading said stored node statuses;
identifying said network as comprising N nodes where N is the number of node statuses that have been stored and read;
identifying an immediately adjacent, first upstream node by the node identification of the node status stored at an address corresponding to an initial message age; and
if N>2, identifying any additional upstream nodes by the node identifications of the node statuses stored at addresses corresponding to said initial message age that has been aged by said additional upstream nodes.

21. A method for operating a network as claimed in claim 10 wherein said status messages and corresponding node statuses further include data representative of operational characteristics of their corresponding nodes, said method further comprising determining the status of said network from said stored node statuses.

22. A method for operating a network as claimed in claim 21 wherein said data representative of the operational characteristics of their corresponding nodes comprises at least one node characteristic selected from the following group: an immediately upstream node identification; status of data transmission; status of data reception; status of network retransmission; status of network link; redundant link status; and, data valid.

23. A network having a plurality of nodes, each node comprising:
logic for generating status messages each including at least a node identification and a message age;
logic for periodically transmitting said status messages;
logic for receiving said status messages at each node of said network;
logic for aging said status messages at each node of said network; and
logic for retransmitting said aged status messages at each node of said network.
